(19) United States
(12) Patent Application Publication
(10) Pub. No.: US 2019/0253698 A1
(43) Pub. Date: Aug. 15, 2019

(54) Display Arrangement Utilizing Internal Display Screen Tower Surrounded by External Display Screen Sides

(71) Applicant: vStream Digital Media, Ltd., Dublin (IE)

(72) Inventors: Niall O'DRISCOLL, Dublin (IE); Andrew JENKINSON, Dublin (IE)

(21) Appl. No.: 15/777,036

(22) PCT Filed: Dec. 28, 2016
(86) PCT No.: PCT/IB2016/058057

§ 371 Date: May 17, 2018

Related U.S. Application Data
(60) Provisional application No. 62/273,942, filed on Dec. 31, 2015.

(51) Int. Cl. H04N 13/395; G09F 27/00; G09F 19/22; G09F 15/00; G09F 9/302; G09G 3/00; G06F 3/14

(52) U.S. Cl. CPC H04N 13/395; G09F 27/00; G09F 19/22; G09G 2300/026; G09F 9/3026; G09G 3/003; G06F 3/1423; G09F 15/0075

(57) ABSTRACT

A display arrangement suitable for stadiums, shopping malls, or other locations with open areas includes an upstanding support structure having a plurality of support structure sides on which stacked display screen arrangements are disposed. An enclosure surrounds all sides of the upstanding support structure, and has a plurality of enclosure sides on which stacked display screen arrangements are arrayed. The display arrangement utilizes at least one processor by which the stacked display screen arrangements on the enclosure sides allow for integrated foreground, middle ground, and background movements. At least one of the upstanding support structure and the enclosure includes a particularly adapted cooling arrangement.

This application claims priority to U.S. Provisional Application 62/273,942, filed Dec. 31, 2015, the entire disclosure of which is incorporated herein by reference.

### BACKGROUND OF THE INVENTION

The present invention utilizes an external cube and an internal pillar arrangement as part of an original concept, referred to at times below as “The Cube,” developed by vStream Digital Media Ltd. to address certain challenges in the stadium/shopping mall market. Challenges for a stadium and team owners include the following.

1. A need for additional sponsorship assets to license to sponsors;
2. A need to increase footfall and dwell time pre- and post-event;
3. A requirement to engage visitors/fans in an interactive manner offline (in-stadia) that could “continue the story” online (at home); and
4. The need to dominate large, open spaces to attract large flows of people. Similar key challenges for malls include the following.
5. A need to create activations for “partner brands,” such as those around Spring-Summer fashion, cars, movie launches, etc.
6. A need to create a “leisure destination” to increase footfall and dwell time.
7. A need to create a dominant, sculptural installation to center an atrium, which would be flexible enough to adapt to the space for different activations.

Advertising and media agencies are an additional constituent. These require new platforms to create engaging content to activate sponsorships or partnerships. In a world where there is a huge amount of noise and distraction for a consumer or fan, a flexible platform that allows for stunning and unique visual representation, as well as multiple forms of interaction, increases the chance, time, and quality of each engagement, ultimately affecting the company either in the value of the brand collateral or directly in increased sales.

### SUMMARY OF THE INVENTION

The original “Cube” concept is a series of transparent screens attached together in an approximately 2.5 cubic foot structure. Each “Cube” would be modular, such that one cube could attach to another cube to form a pillar of cubes or a larger cube. Each cube module would be interactive and also allow for a three-dimensional image to appear within the cube itself.

The software runs the cube itself in allowing multiple cubes to work together as a single entity when conjoined, extending the visual and interactivity of each cube to the new single entity. A second part of the software allows for the simple programming of the cube(s) by a creative agency, for example, dragging and dropping assets such as video or games, onto each side of the cube through a remote platform. This software would also allow for multiple cubes to be programmed at once, with geo-targeting and demographic targeting available as part of that programming.

Current “Cube” and “Pillar” Design (V.1)

Version 1 of the cube is built as a large, non-modular installation, made up of the following key elements:

1. An exoskeleton of brushed steel;
2. Four TOLED screens per side;
3. Two LED screens per side;
4. An internal “Pillar” made up of two LED screens per side;
5. A structure to hold the TOLEDs in place in a solid and safe manner while minimizing the visual interruption of the larger image (made up of all screens running simultaneously);
6. An infrared (IR) frame around each side and a “Microsoft Kinect” or any other suitable interface on each side to allow for interaction;
7. A series of computers hidden within the structure to allow for all screens within the cube and Pillar to work simultaneously and consecutively to act as a “single canvas,” allowing for a unique, multilayered audio-visual experience on an X, Y and Z plane; and
8. A fan array designed to keep the correct air-flow to insure the safe and uninterrupted running of all technology within “The Cube” (including “The Pillar”).

Aesthetically, all design has worked towards creating something that is a beautiful piece of sculpture that can dominate a large space, such as an atrium, and change the dynamic of that space and how people move through it. The use of transparent screens allows for light to pass through the structure, while the use of a strong exoskeleton gives the piece a strong sense of line and form.

Functionally, the cube acts as both passive signage and interactive installation, depending on the content type. Visually, the cube creates a multi-layered, three-dimensional canvas. Compositionally, the canvas can be used in an X,Y,Z formation, allowing the standard XY composition as well as the Z, through use of the Pillar and TOLED interaction, e.g., in a standard film composition, with foreground, middle ground, and background—in The Cube, the foreground can be put on the TOLEDs on the side of the cube directly in front of the viewer, the middle ground can be put on the Pillar screens within the cube, and the background can be put on the image on the back of the TOLEDs on the opposing side of the cube to the one someone directly faces. “The Cube” software can then allow for integrated movement across all three to allow for a sense of parallax between the foreground, mid-ground, and background as if the camera were to dolly left to right within this imaginary shot.

Briefly, therefore, the display arrangement, suitable for stadiums, shopping malls, or other locations with open areas, can include an upstanding support structure having a plurality of support structure sides on which stacked display screen arrangements are disposed. An enclosure preferably surrounds all sides of the upstanding support structure, and has a plurality of enclosure sides on which stacked display screen arrangements are arrayed. The display arrangement utilizes at least one processor by which the stacked display screen arrangements on the enclosure sides allow for integrated foreground, middle ground, and background movements. At least one of the upstanding support structure and the enclosure includes a particularly adapted cooling arrangement.

### BRIEF DESCRIPTION OF THE DRAWINGS

FIG. 1 is a schematic view, in perspective, of one configuration of the invention.

FIG. 2 is a cross section seen along line 2-2 of FIG. 1.

FIG. 3 is a plan view showing one option for closing off the top of the external cube.

FIG. 4 is a view similar to that of FIG. 3, but with the top of the cube removed.

FIG. 5 is a view similar to FIG. 3 but showing another option.

FIG. 6 is an elevation view of an embodiment of the cube.

FIGS. 7 and 8 are schematic side section views showing central pillars in an embodiment.

FIG. 9 provides an enlarged sectional illustration of a divider element.

FIG. 10 provides a plan view of an embodiment the cube corner.

FIG. 11 is a sectional view along line A-A in FIG. 10.

FIG. 12 shows a modified arrangement according to the invention.

FIGS. 13 and 14 supply additional illustrations of certain elements shown in FIG. 12.

FIG. 15 is a schematic illustration showing electrical supply proximity preferences.

FIG. 16 is a cut-away view of the interior of the cube shown in FIG. 1.

FIG. 17 is a side view of an embodiment of the cube when TOLEDs and back painted glass panels G are utilized.

FIG. 18 is a cut-away view of the interior of the cube shown in FIG. 16, but showing the interior of the cube shown in FIG. 17.

FIG. 19 is a side view of the cube when the TOLEDs and light emitting devices or televisions are used in place of the back painted glass panels.

FIG. 20 is another view similar to FIG. 16, while FIGS. 21-22 are variations of the arrangement shown in FIG. 17.

FIG. 23 is a sectional view showing certain painting/coloration details.

FIG. 24 is a view from within the interior of the cube illustrating some TOLEDs and LEDs in the cube frame.

FIG. 25 is a view similar to FIG. 24 but from outside the cube.

FIG. 26 is a view with part of the external cube cut away, showing the pillar in an installed position inside the external cube.

FIG. 27 illustrates aspects of the central pillar.

FIG. 28 shows mounting flanges located at the top of the pillar frame including openings or cutouts within which cooling devices are receivable.

FIG. 29 shows a hinged attachment facilitating mounting, servicing, and replacement of the pillar screens.

FIG. 30 shows openings in back panels of the pillar to permit ventilation passage of wiring.

### DETAILED DESCRIPTION OF THE INVENTION

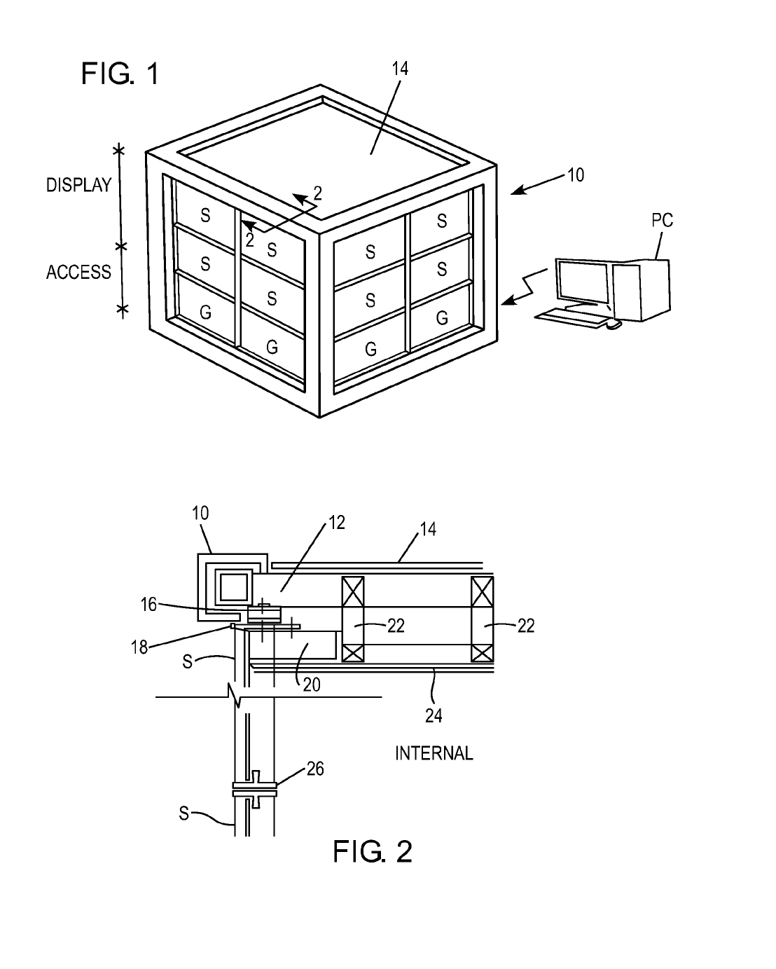

FIG. 1 is a schematic view, in perspective, of one configuration of part of the invention (“The Cube”), which includes both an external cube and an internal pillar received within the external cube. FIG. 1 illustrates two of four sides of the external cube, as well as the top of the cube. The cube could also be open, i.e. provided with no top, if desired. In the illustrated arrangement, each external side of the cube includes two rows of organic light-emitting device (OLED) screens S and removable back painted glass panels G supported within a stainless steel frame to be described further. Other suitable configurations are, of course, possible. In the illustrated configuration, the glass panels G may be back painted in such a way as to match the OLED screens when the OLED is in an “off” state. In this particular configuration, access to the interior of the exterior cube can be made available by removal of one or more of the panels G. A polished chrome exoskeleton 10 surrounds an interior, approximately cube-shaped endoskeleton 12 formed by an approximately cube-shaped steel frame. In one preferred alternative arrangement, the screens S may be transparent organic light-emitting devices (TOLEDs), and conventional light emitting devices (LEDs) or televisions may be used in place of the back painted glass panels G.

FIG. 2 is a cross section seen along line 2-2 of FIG. 1, and shows the endoskeleton 12 as surrounded at its externally exposed surfaces by the exoskeleton 10. Also illustrated in FIG. 2 is a glass panel 14, forming the top of the cube. A spacer 16 supports the endoskeleton 12 at a suitable distance above a flat or flange 18 secured by way of a connection beam 20 to one of several depending members 22 secured to or integrally formed with the endoskeleton 12. The flat or flange 18 helps guide the screens S into place as they are pushed back during installation, and the spacer may be inserted and fixed in place thereafter. A light and/or the illustrated acrylic PERSPEX sheet 24 may be suspended by way of the depending members from the endoskeleton 12. FIG. 2 also shows one type of a suitably configured spacer or divider element 26 separating adjacent OLED screens from one another.

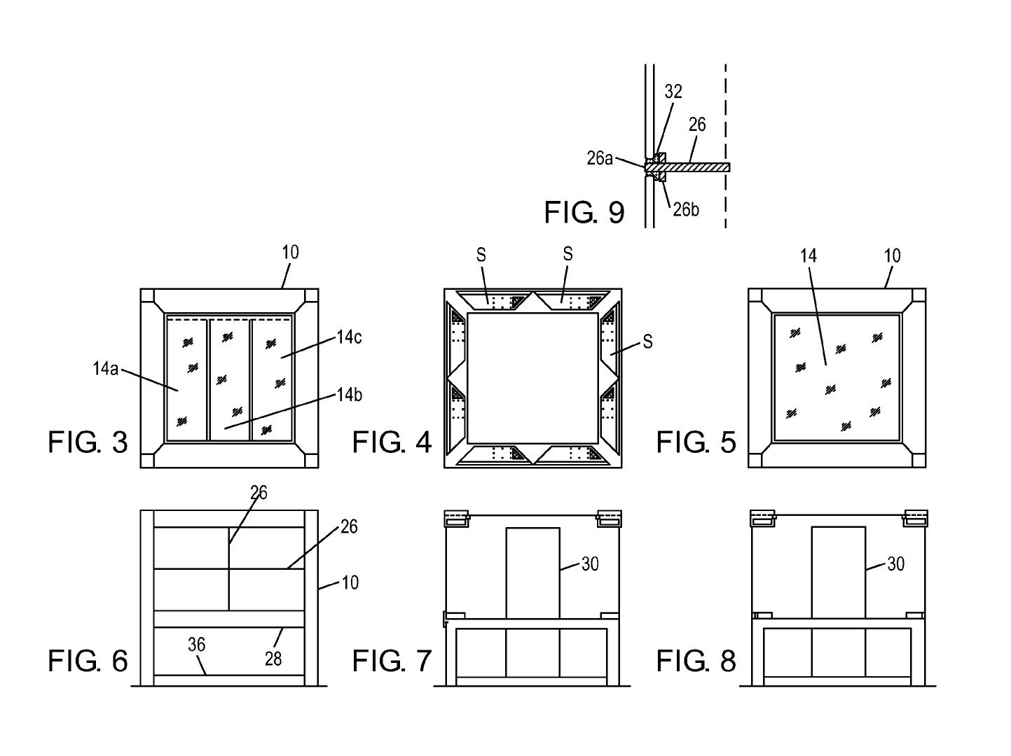

FIG. 3 is a plan view showing one option for closing off the top of the external cube, including three rectangular glass panels 14a, 14b, 14c suitably supported adjacent to one another. FIG. 4 is a view similar to that of FIG. 3, but with the top of the cube removed to illustrate the OLED screens S mounted in position and forming the four cube sides. FIG. 5 is a view similar to FIG. 3 but showing another option using a single glass panel 14 to close off top of the external cube; this other option is also shown in FIG. 1. FIG. 6 is an elevation view of the cube showing horizontal and vertical divider elements 26, to be disposed between adjacent screens S, and a horizontal guide 28 having an L-shaped cross section to aid in both spacing of the screens S and support of the glass panels G, with the screens S and panels G removed. FIGS. 7 and 8 are schematic side section views showing central pillars 30, to be described later, received within cube framing elements. FIG. 9 provides an enlarged sectional illustration of one of the divider elements 26. The divider element 26, which has a configuration differing somewhat from that of FIG. 2, may be brushed stainless steel or another suitable material, and includes an exposed outer end 26a, forming part of one of the cube sides, and flanges 26b spaced from the outer end 26a. Silicone or other suitable bonding and cushioning material 32 is interposed between the screens S and the divider element 26.

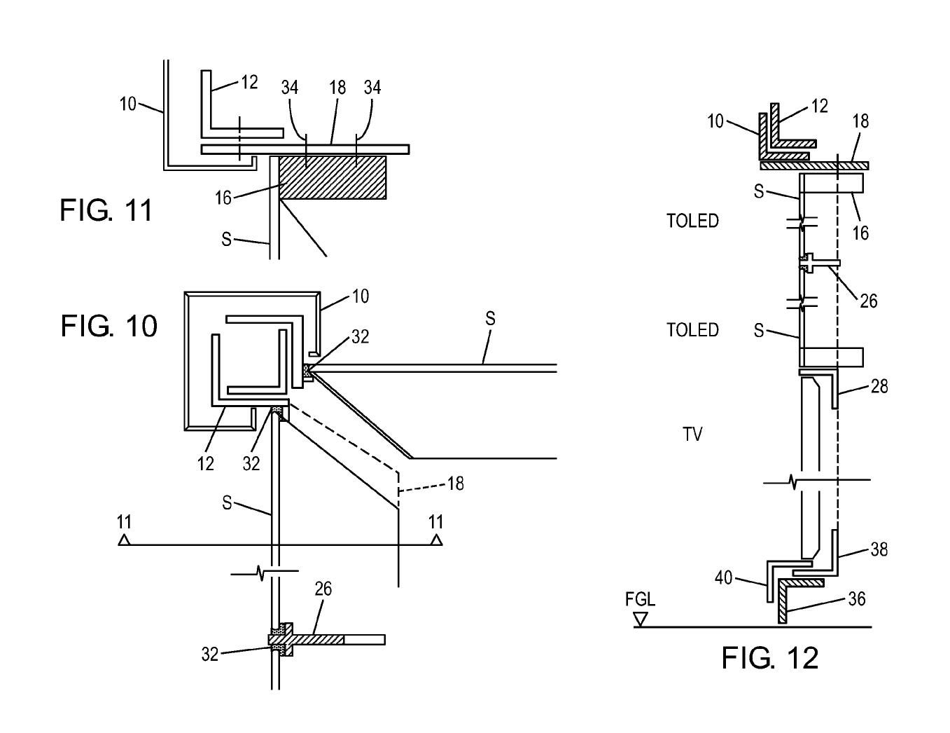

In the plan view of the cube corner provided by FIG. 10, the endoskeleton 12 is again illustrated with its externally exposed surfaces surrounded by the exoskeleton 10. Adjacent lateral portions of screens S, forming parts of different adjacent cube sides, are joined together in the manner shown, with silicone or other suitable bonding and cushioning material 32 provided between the screens S and surfaces of the endoskeleton 12. It will be seen that the endoskeleton 12 shown in FIG. 10 differs somewhat from that shown in FIG. 2, in that the element of endoskeleton 12 shown in FIG. 10 is composed of multiple parts, while the endoskeleton 12 in FIG. 2 is shown as being unitary.

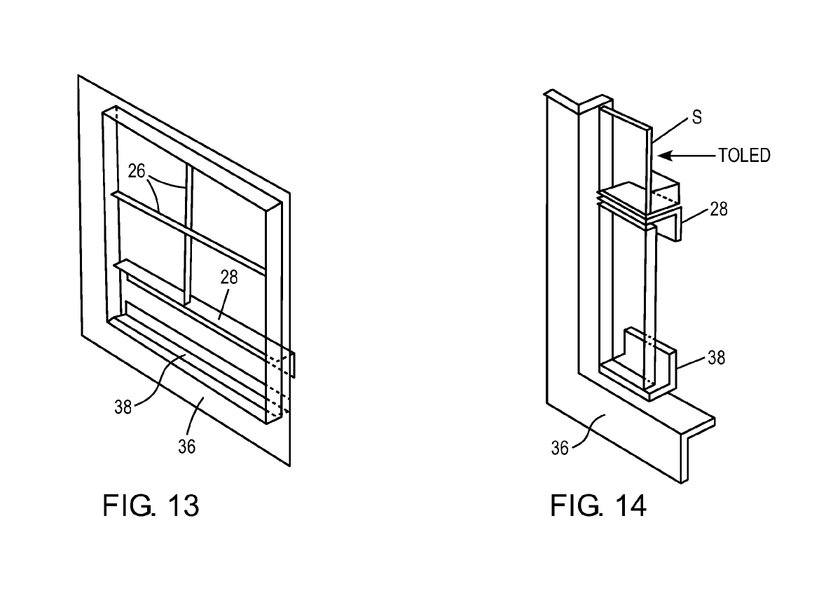

FIG. 11 is a sectional view along line 11-11 in FIG. 10, and provides an enlarged illustration of certain elements shown in FIG. 2. As FIG. 11 schematically shows, the spacer 16 may be secured by screws, rivets, or other suitable fasteners 34 to the flat or flange 18. FIG. 12 shows a slightly modified arrangement in which the exoskeleton 10 rather than the endoskeleton is fixed directly to the flat or flange 18. FIG. 12 also illustrates one configuration of the external cube base, which includes a lower horizontal beam 36 (see FIG. 6 as well) having an L-shaped cross section as well as a horizontal guide 38 oriented parallel to the horizontal guide 28. The guides 28, 38 are intended to form guides for lateral insertion of the glass panels G, conventional light emitting devices (LEDs), or televisions to be utilized. A polished chrome beam or other decorative covering 40 may be mounted between the glass panels G, conventional light emitting devices (LEDs), or televisions utilized and the guide 38 in order to cover all or part of the beam 36. FIGS. 13 and 14 supply additional illustrations of certain elements shown in FIG. 12, but with the decorative covering 40 removed.

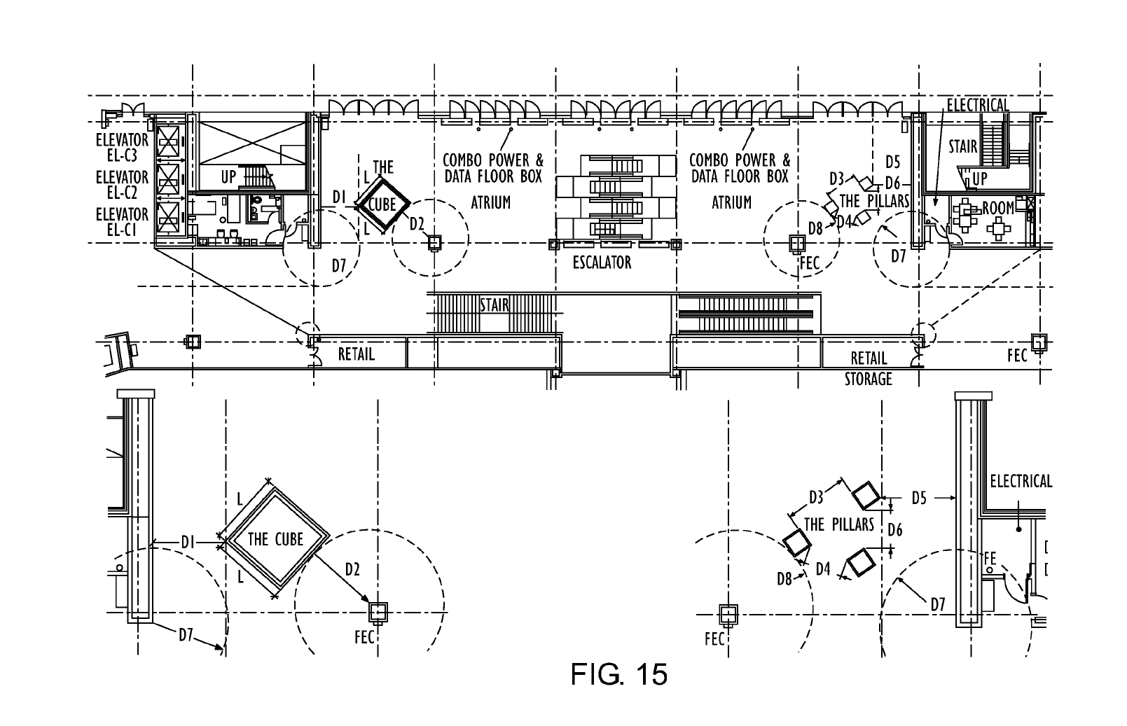

FIG. 15 is a schematic illustration showing electrical supply proximity preferences for the cube, at left, and for central pillars 30, at right. Referring to FIG. 15, dimensions represented are L=9′ 8¼″, D1=10′, D2=9′ 11¾″, D3=8′ 5¾″, D4=5″ 1¾″, D5=10′ 8¾″, D6=5′ 1¾″, D7=10′, and D8=10′ ¼″.

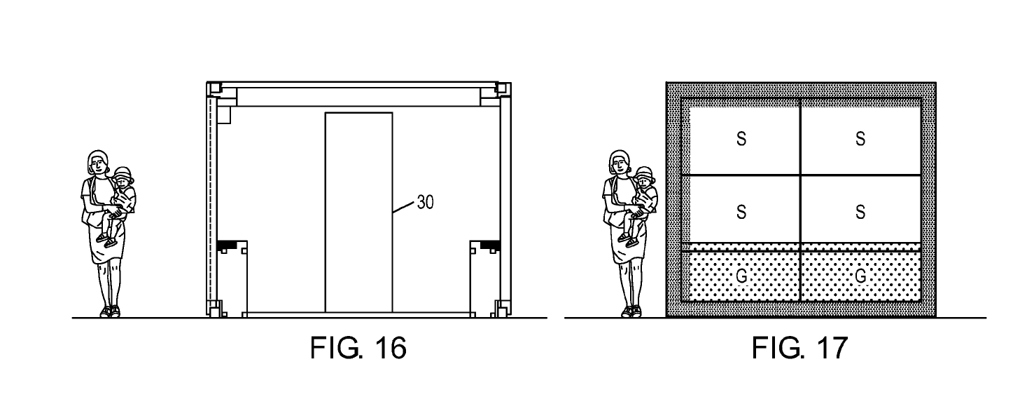

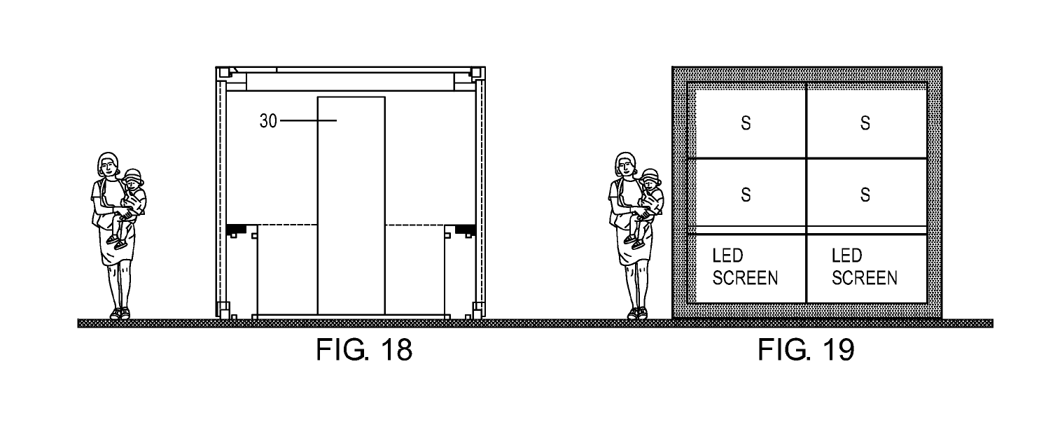

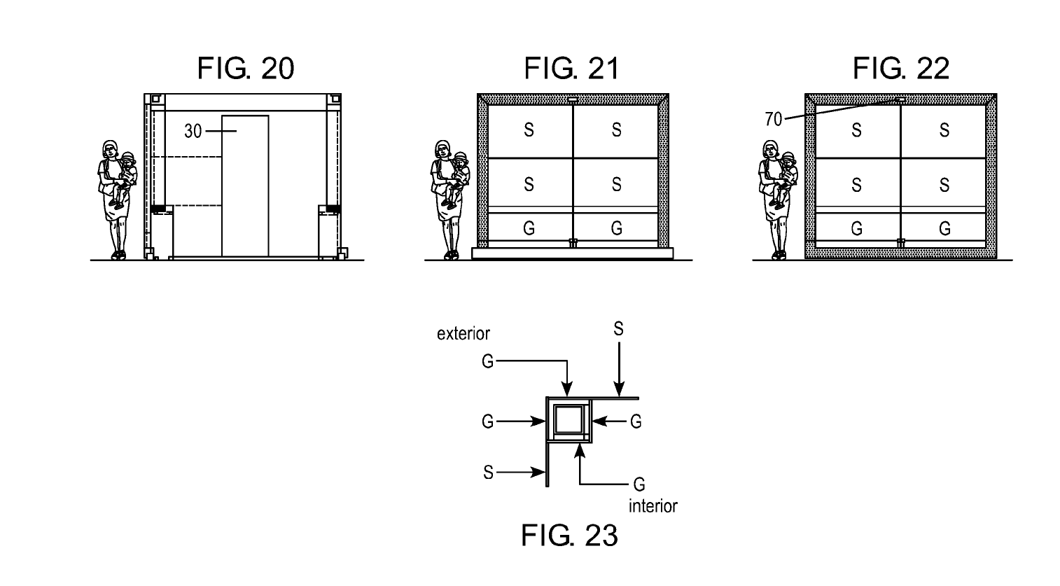

FIG. 16 is a cut-away view of the interior of a cube as shown in FIG. 1, showing a central pillar 30 located within the external cube, while FIG. 17 is a side view of the cube when the screens S are TOLEDs and back painted glass panels G are utilized. FIG. 18 is a cut-away view of the cube interior similar to FIG. 16, while FIG. 19 is a side view of the cube when the screens S are TOLEDs and light emitting devices (LEDs) or televisions are used in place of the back painted glass panels G. FIG. 20 is another view similar to FIG. 16, while FIGS. 21-22 show a pair of variations of the arrangement shown in FIG. 17, with the screens S being TOLEDs, with back painted glass panels G being utilized, and with a connect opening 70 in the exoskeleton shown in FIG. 22. FIG. 23 is a sectional view showing certain exoskeleton interior and exterior painting/coloration details when the screens S are TOLEDs, and with back painted glass panels G forming part of the exoskeleton.

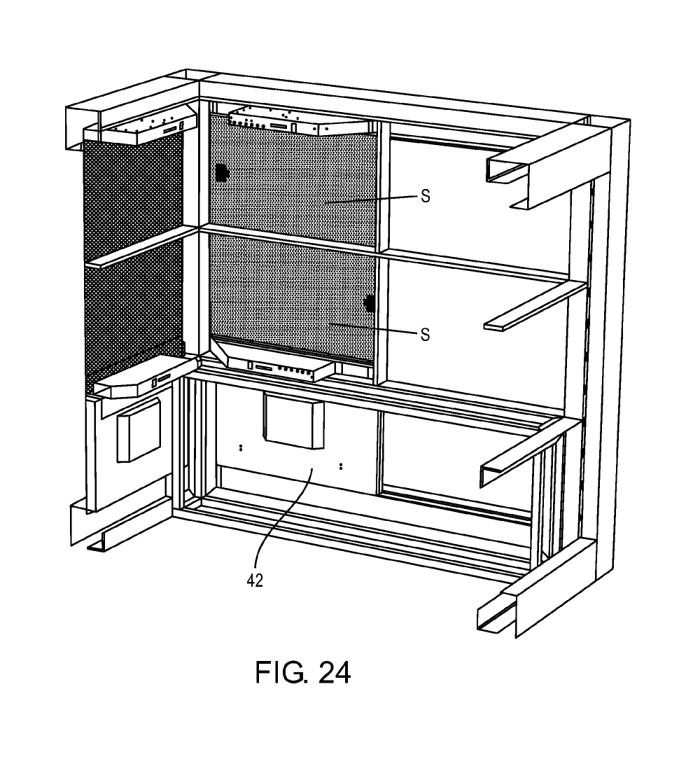

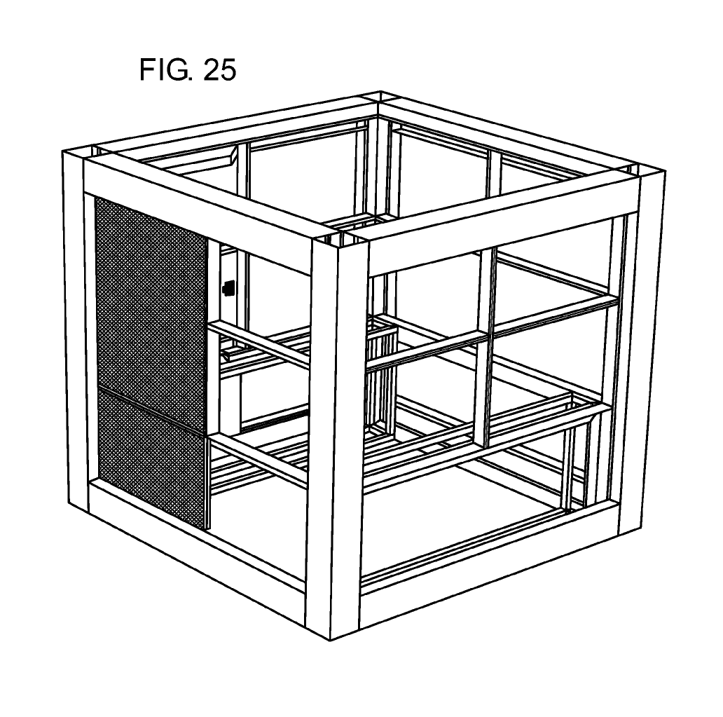

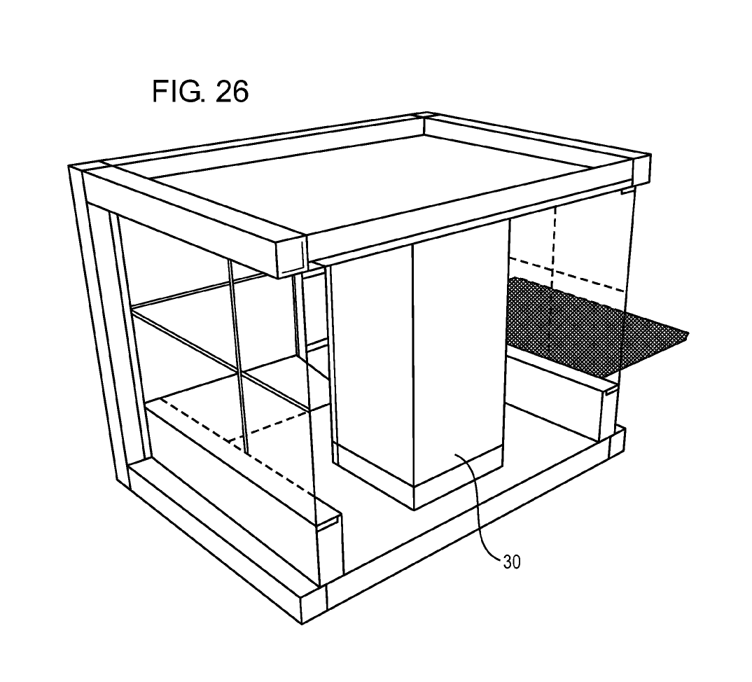

FIG. 24 is a view from within the interior of the cube illustrating some TOLEDs S and LEDs 42 mounted in position within the cube frame. FIG. 25 is a view similar to FIG. 24 but from the exterior of the cube. FIG. 26 is a view with part of the external cube cut away, showing the pillar in an installed position inside the external cube.

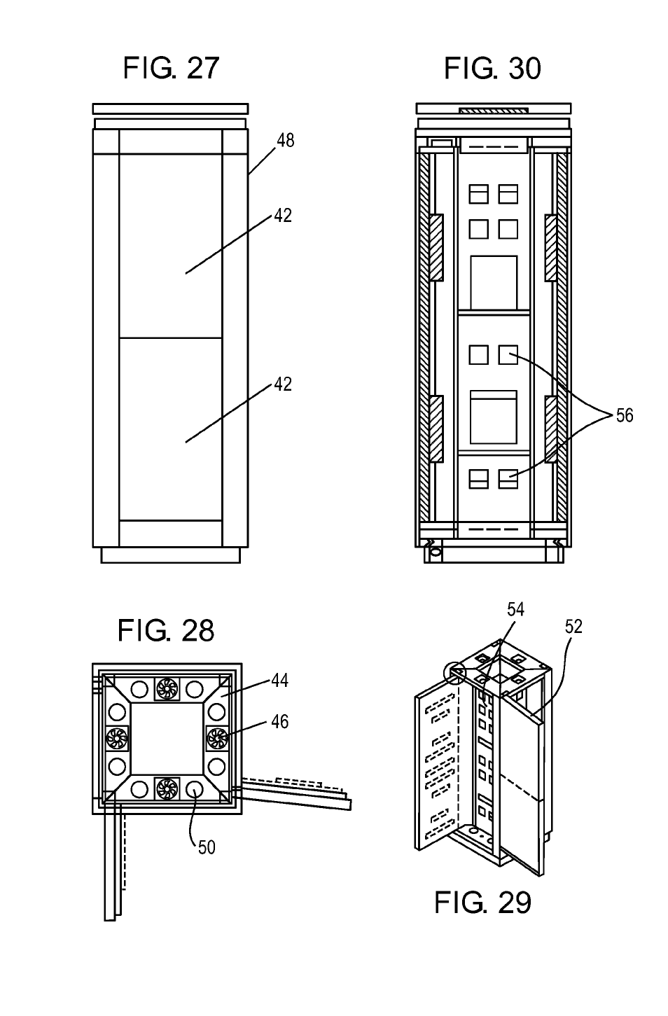

FIG. 27 illustrates aspects of the central pillar 30, which, as illustrated, is made up of two LED screens 42 per side. Significant features of the pillar 30 include mounting flanges 44 (FIG. 28), located at the top of the frame 48 within which the screens 42 are located, having openings or cutouts 50 within which fans 46 or other cooling devices are receivable. It is also possible to appropriately mount an additional LED screen on top of the pillar, as long as accommodations for adequate ventilation and cooling are made. Also of significance is the hinged attachment of doors or panels 52 (FIG. 29) to the frame 48, which facilitates mounting, servicing, and replacement of the screens 42 as needed. At least one of the upstanding support structure and the enclosure includes a cooling arrangement; here, FIG. 30 shows openings 56 in the back panels 54 to permit both ventilation of the pillar 30 and passage of wiring to interconnect the screens 42 with a personal computer PC (schematically represented in FIG. 1) or other input.

The external cube and central pillar, together, thus form a display arrangement having the pillar as an upstanding support structure with a plurality of support structure sides on which stacked display screen arrangements formed by the screens 42 are disposed, and an enclosure for that upstanding support structure. This enclosure, formed by the external cube, surrounds all support structure sides of the upstanding support structure, and has a plurality of enclosure sides on which stacked display screen arrangements, formed by painted glass panels G, TOLEDs, LEDs, and/or televisions as appropriate, are arrayed.

Passersby are able to interact with a PC, CPU, or other suitable control device in several ways, including via a touch screen that could be separate from or incorporated into one or more of the TOLEDs, via infrared sensors or sensors of other types associated with the bezel formed by the polished chrome exoskeleton 10, an infrared sensing device located at the base of the exterior cube. Other forms of communication, such as Wi-Fi, Bluetooth wireless technology, and so on, are also contemplated.

Returning now to the cube, cube software architecture is configured as set out in the following discussion.

The cube has one PC per side, and each PC runs custom software. The cube platform is a cloud based architecture, which consists of a NOC (Network Operations Center) and Agent software on each machine.

### The Cube Agent—Software Architecture

Every PC has an agent that monitors the cloud platform; this agent is the NOC.

The agent is a piece of software written in NODE.js with a local postgres database. The Agent boots upon startup and contacts the NOC to register and ascertain which commands to run, e.g., create app, update app, run app, remove app, make app x main app, get app, get file, set file. HANA designates optional, commercially available software, developed and owned by SAP, that is utilized in certain architecture versions.

In the illustrated embodiments, Apps are software applications written in Unity or Web Tech (HTMLS, JS, NODE); however, any other suitable coding language may be used. In the embodiments presented herein, each app is added to a git repository with vStream SSH credentials. Once the repository URL is shared with the NOC, all content for the app can be deployed to the relevant machine. The flow is as follows:

When an app is run, its PID (process ID) is stored in the local Postgres database. If a new app is instigated via the ‘run app’ command, the currently running app's ID is retrieved from the database and the process is killed, allowing the new app to run.

### The Cube NOC Architecture

The cube NOC (Network Operations Center) manages all cube installations and facilitates deployment and scheduling of running apps on each cube and pillar. At a simple level, NOC is a web server running on an Amazon Web Server (AWS), for instance, which is a node.js application which manages the communications with the user interface (UI) and each machine.

Each machine has a description, which takes the format Installation name>Description>Machine name (e.g. Levis Stadium>cube>Side 1). Each machine registers itself with the NOC using the unique details. Also included in the representation above are the virtual private cloud (VPC) and the relational database service (RDS) utilized in this particular architecture. Once registered, the NOC web server can then send commands to the machine, listed below.

Load balancing and scalability is handled using AWS services. Elastic Balancer is Amazon's infrastructure to manage the load and number of servers. Elastic beanstalk deploys the server code from a local development machine to the cloud server.

Below is the UI for the NOC

Below is the UI showing available commands

Below is the UI showing the available apps on a specific machine

### Cube PC Screen Configuration

The cube PC has 6 screens attached, all controlled by a single PC with a HDMI connection. The bottom two screens are LED, the top four are TOLED. The top two screens are fixed to the frame upside down, which poses an issue as the screens do not have the ability to invert the content. Therefore it was necessary to facilitate this through software. The two top TOLED screens are inverted with the graphics card by altering the NVIDIA graphics card driver. The desktop is warped. It rewrites the position of the pixels using a matrix so as to display the content on screen 1 and 2 (below).

| | |
|---|---|
| Screen 1-TOLED | Screen 2-TOLED |
| Content inverted | Content inverted |
| Screen 3-TOLED | Screen 4-TOLED |
| Content normal | Content normal |
| Screen 5-LED | Screen 6-LED |
| Content normal | Content normal |

The overall display arrangement, with the processor formed by the PC and the HDMI connection mentioned, thus allow the stacked TOLED and/or LED display screen arrangements on sides of the cube to provide the integrated foreground, middle ground, and background movements mentioned at the outset.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of any ultimately issued claims and equivalents thereof.

1. A display arrangement comprising:
an upstanding support structure having a plurality of external support structure sides,. each of the external support structure sides including a pair of stacked display screen arrangements; and
an enclosure surrounding all support structure sides of the upstanding support structure, the enclosure having a plurality of external enclosure sides, each of the external enclosure sides including stacked rows of multiple display screen arrangements.

2. The display arrangement according to claim 1, further comprising at least one processor by which the stacked display screen arrangements and the stacked rows of multiple display screen arrangements allow for integrated foreground, middle ground, and background movements.

3. The display arrangement according to claim 1, wherein at least one of the upstanding support structure and the enclosure includes a cooling arrangement.

4. The display arrangement according to claim 1, wherein screens of the pair of stacked display screen arrangements are LED screens.

5. The display arrangement according to claim 4, wherein the stacked rows of multiple display screen arrangements include any of painted glass panels, TOLEDs, LEDs, and televisions.

6. The display arrangement according to claim 4, wherein the stacked rows of multiple display screen arrangements include painted glass panels and any of TOLEDs, LEDs, and televisions.

7. The display arrangement according to claim 2, wherein the processor is formed by a PC with a HDMI connection.

8. The display arrangement according to claim 1, wherein the enclosure includes an interior frame having a shape approximating a cube.

9. The display arrangement according to claim 8, wherein the frame is formed at least primarily of steel.

10. The display arrangement according to claim 3, wherein the cooling arrangement includes a plurality of cooling devices mounted to the upstanding support structure.

11. The display arrangement according to claim 10, wherein the upstanding support structure includes a frame and flanges located at a top of the frame with openings or cutouts to receive the cooling devices.

12. The display arrangement according to claim 10, further comprising hinged doors or panels carrying the display screen arrangements disposed on the sides of the upstanding support structure.

13. The display arrangement according to claim 12, wherein the upstanding support structure includes back panels relative to which the hinged doors or panels are pivotable.

14. The display arrangement according to claim 2, wherein at least one of the external enclosure sides has six of said display screen arrangements arrayed thereon, and wherein said six display screen arrangements are all controlled by a single PC with a HDMI connection.

15. The display arrangement according to claim 13, wherein the back panels further include ventilation openings.

16. The display arrangement according to claim 1, further comprising flanged divider elements separating adjacent stacked display screen arrangements arrayed on said external enclosure sides from one another.

17. The display arrangement according to claim 16, wherein the flanged divider elements include exposed outer ends forming parts of the enclosure sides.

18. The display arrangement according to claim 16, further comprising bonding and cushioning material interposed between the divider elements and the adjacent stacked display screen arrangements.

19. The display arrangement according to claim 1, wherein each of the stacked screen arrangements in at least one of the stacked rows is disposed between L-shaped guides, permitting lateral insertion of the stacked screen arrangements in said at least one of the stacked rows.

20. The display arrangement according to claim 8, further comprising a polished decorative covering overlying edges of the enclosure.
